(19) United States
(12) Patent Application Publication
(10) Pub. No.: US 2021/0232735 A1
(43) Pub. Date: Jul. 29, 2021

(54) Simulation-Based Material Characterization

(71) Applicant: Disney Enterprises, Inc., Burbank, CA (US)

(72) Inventors: Moritz Niklaus Bächer, Zürich (CH); Gabriela Natalia Venturini, North Hollywood, CA (US); Christian Gabriel Schumacher, Zürich (CH); Cynthia A. Marinaro, Glendale, CA (US); Alfredo Ayala, West Covina, CA (US); Lars Espen Knoop, Zürich (CH); Philip J. Jackson, Glendale, CA (US)

(21) Appl. No.: 16/776,089

(22) Filed: Jan. 29, 2020

(51) Int. Cl. G06F 30/23; G06F 111/10

(52) U.S. Cl. CPC G06F 30/23; G06F 2111/10

(57) ABSTRACT

A system for performing simulation-based material characterization includes a computing platform having a hardware processor and a system memory storing a software code. The hardware processor executes the software code to obtain a result of a physical test performed on a material, selects a parameterized model of the material based on the obtained result, and performs a simulation of the physical test using the parameterized model to generate a simulated result. The hardware processor further executes the software code to compare the simulated result with the obtained result of the physical test on the material, and adjusts one or more parameter value(s) of the parameterized model, based on the comparison, to improve the simulated result, and predict, after adjusting the parameter value(s), one or more characteristics of the material based on the parameterized model.

### BACKGROUND

The accurate, stable, and robust simulation of or materials typically used in soft robotics relies crucially on the accuracy of the parameters used in the simulation. For skin simulations, for example, hyperelastic material models are often used due to their ability to approximate the behavior of elastomeric materials, such as silicone and urethane, for instance.

Traditionally, characterization of elastomers is done by testing the uniaxial and biaxial, and sometimes triaxial (i.e., volumetric) behavior of the material. Material parameters are then fitted to the resulting data using analytical models that assume a particular deformation mode in the sample. However, multiple tests are typically required for good fits, making such traditional solutions time consuming because biaxial, and particularly triaxial setups are relatively complex and costly. Moreover, because the stiffness of a material depends on the resolution and order of finite elements that are used for the simulation, reliance on analytical material models for parameter estimation can lead to inaccurate predictions of material characteristics, such as elasticity, or, more generally, the deformation of an object and the corresponding stresses and strains under a specified load. Consequently, there is a need in the art for a material simulation solution that is fast, cost effective, and accurately describes one or more characteristics of the material being simulated.

### SUMMARY

There are provided systems and methods for simulation-based material characterization, substantially as shown in and/or described in connection with at least one of the figures, and as set forth more completely in the claims.

### BRIEF DESCRIPTION OF THE DRAWINGS

FIG. 1A shows a diagram of an exemplary system for characterizing material properties, according to one implementation;

FIG. 1B shows a diagram of an exemplary system for characterizing material properties, according to another implementation;

FIG. 2 shows diagrams of an exemplary uniaxial and an exemplary biaxial testing apparatus;

FIG. 3 shows diagrams of a physical test performed on a material using a uniaxial testing apparatus and a corresponding simulation of the physical test using a parameterized model of the material, according to one implementation;

FIG. 4 shows a flowchart presenting an exemplary method for simulating material characteristics, according to one implementation;

FIG. 5 shows a table of simulation parameters, reparameterizations of those simulation parameters, and corresponding optimization parameters for three exemplary hyperelastic material models, according to one implementation; and

FIG. 6 shows a cutaway view of an object manufactured based on material characteristics determined by the systems and according to the methods disclosed in the present application, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

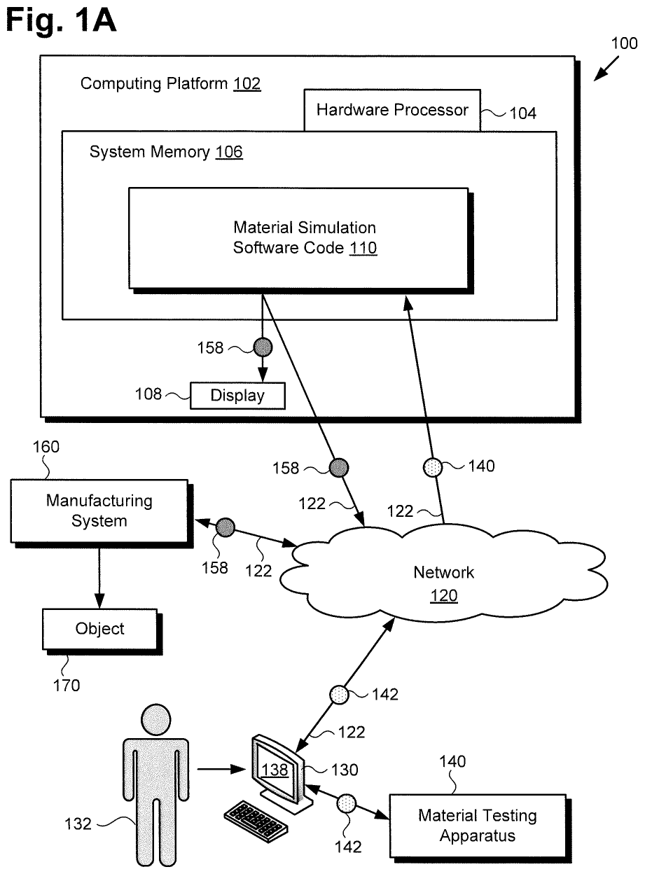

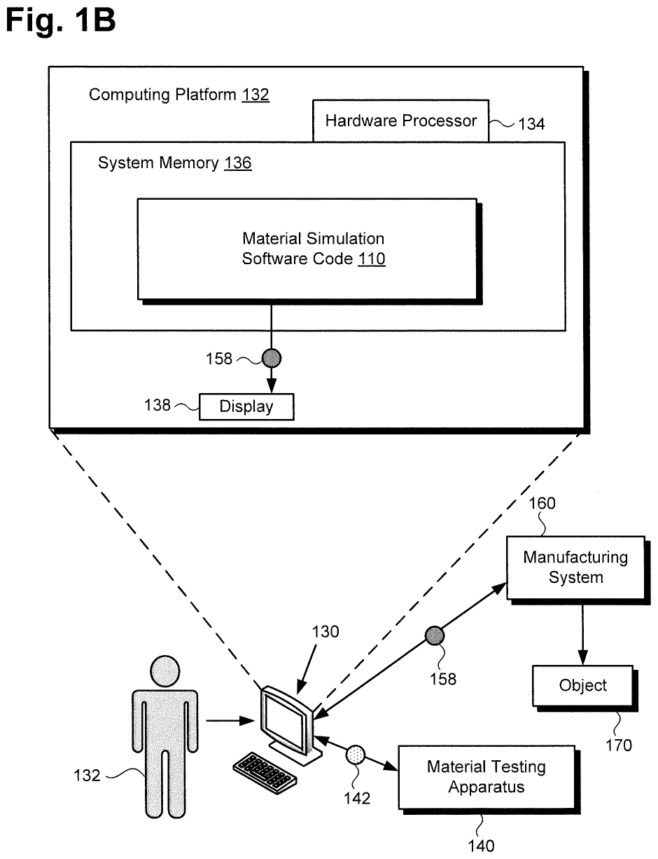

FIG. 1A shows a diagram of an exemplary system for characterizing material properties, according to one implementation. As shown in FIG. 1A, material simulation system 100 includes computing platform 102 having hardware processor 104, and system memory 106 implemented as a non-transitory storage device. According to the present exemplary implementation, system memory 106 stores differentiable material simulation software code 110. In some implementations, material simulation system 100 may include display 108, which may be integrated with computing platform 102, or may be a discrete display communicatively coupled to computing platform 102.

As further shown in FIG. 1A, material simulation system 100 is implemented within a use environment including communication network 120, user system 130 including display 138, user 131 utilizing user system 130, material testing apparatus 140 coupled to user system 130, test result 142 output by material testing apparatus 140, and one or more material characteristics 158 determined based on test result 142 (hereinafter also “obtained result 142”). In addition, FIG. 1A shows object 170 manufactured by manufacturing system 160 based on one or more material characteristics 158. Also shown in FIG. 1A are network communication links 122 interactively connecting user system 130 and manufacturing system 160 with material simulation system 100 via communication network 120.

By way of overview, it is noted that in engineering, it may be advantageous or desirable to characterize materials in order to be able to predict their behavior in simulations. One notable advantage of the novel and inventive technique disclosed in the present application is that material characteristics are directly characterized in the context of simulation. This has the following advantages: (1) Higher accuracy of estimated parameters because we directly take a simulation representations into account. (2) Although conventional analytical model fitting assumes uniaxial, biaxial, and triaxial behavior to be decoupled, with simulation representations of test specimens we can advantageously couple these behaviors and can achieve higher prediction accuracy with fewer mechanical tests.

The material characterization performed by the material simulation systems and according to the methods disclosed herein may be used in the design of objects made of the characterized material, but assuming a variety of different geometries. In other words, the material characterizations disclosed in the present application advantageously enable the simulation of objects having arbitrary shapes based on a characterization performed using a small test sample of the material.

It is noted that although manufacturing system 160 is depicted as distinct from material simulation system 100, that representation is merely exemplary. In other implementations, manufacturing system 160 may be included as a component of material simulation system 100, and may be integrated with material simulation system 100, or may be remote from but communicatively coupled to material simulation system 100. That is to say, in some implementations, manufacturing system 160 may be under the control of computing platform 102.

It is further noted that, in various implementations, one or more material characteristics 158, when simulated using differentiable material simulation software code 110, may be stored in system memory 106 and/or may be copied to non-volatile storage (not shown in FIG. 1A). Alternatively, or in addition, as shown in FIG. 1A, in some implementations, one or more material characteristics 158 may be transferred to manufacturing system 160 for manufacture of object 170, for example by being transmitted to manufacturing system 160 via network communication links 122 of communication network 120.

Although user system 130 is shown as a desktop computer in FIG. 1A, that representation is merely exemplary. More generally, user system 130 may be any suitable mobile or stationary computing device or system that implements data processing capabilities sufficient to provide a user interface, support connections to communication network 120, and implement the functionality ascribed to user system 130 herein. For example, in other implementations, user system 130 may take the form of a laptop computer, tablet computer, or smartphone, for example. Moreover, in some implementations, user system 130 may take the form of a wearable personal communication device, such as a smartwatch or another smart personal item worn by user 131 and including display 138. It is noted that display 138, as well as display 108 of material simulation system 100, may take the form of a liquid crystal display (LCD), a light-emitting diode (LED) display, an organic light-emitting diode (OLED) display, or any other suitable display screen that performs a physical transformation of signals to light.

It is also noted that although the present application refers to differentiable material simulation software code 110 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102, or to a hardware processor of user system 130 (identified as hardware processor 134 below by reference to FIG. 1B). Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

Moreover, although FIG. 1A depicts differentiable material simulation software code 110 as being stored as a single set of software instructions, that representation is also merely exemplary. More generally, material simulation system 100 may include one or more computing platforms, such as computer servers for example, which may form an interactively linked but distributed system, such as a cloud-based system, for instance. As a result, hardware processor 104 and system memory 106 may correspond to distributed processor and memory resources within material simulation system 100. Thus, various software modules included in differentiable material simulation software code 110 may be stored remotely from one another and may be executed by the distributed processor resources of material simulation system 100.

In one implementation, for example, computing platform 102 of material simulation system 100 may correspond to one or more web servers, accessible over a packet-switched network such as the Internet, for example. Alternatively, computing platform 102 may correspond to one or more computer servers supporting a wide area network (WAN), a local area network (LAN), or included in another type of limited distribution or private network.

FIG. 1B shows a diagram of exemplary user system 130 for simulating material characteristics, according to another implementation. It is noted that any features in FIG. 1B identified by reference numbers identical to those shown in FIG. 1A correspond respectively to those previously described features and may share any of the characteristics attributed to those corresponding features by the present disclosure. In addition to the features shown in FIG. 1A, FIG. 1B depicts user system 130 as including computing platform 132 having hardware processor 134 and user system memory 136 implemented as a non-transitory storage device. According the exemplary implementation shown in FIG. 1B, user system memory 136 stores differentiable material simulation software code 110.

The implementation shown in FIG. 1B differs from that represented in FIG. 1A in that differentiable material simulation software code 110 is stored and may be executed locally on user system 130. Moreover, according to the implementation shown in FIG. 1B, user system 130 is communicatively coupled to manufacturing system 160, which, in some implementations, may be a peripheral component of user system 130. Thus, as shown in FIG. 1B, in some implementations, user system 130 may include all or substantially all of the features and functionality of material simulation system 100, in FIG. 1A.

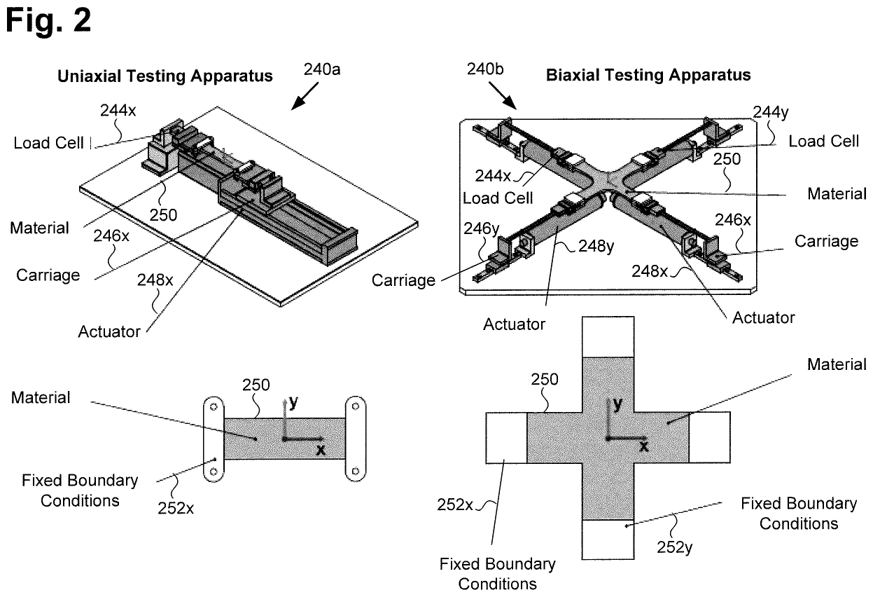

FIG. 2 shows respective diagrams of exemplary uniaxial testing apparatus 240a and exemplary biaxial testing apparatus 240b for performing a physical test on material 250. It is noted that either of uniaxial testing apparatus 240a or biaxial testing apparatus 240b may correspond to material testing apparatus 140, in FIGS. 1A and 1B. As a result, material testing apparatus 140 may share any of the characteristics attributed to either of uniaxial testing apparatus 240a or biaxial testing apparatus 240b by the present disclosure, and vice versa. It is further noted that although FIGS. 1A, 1B, 2, 3, 4, 5, and 6 will be further described by reference to implementations in which material 250 is an elastomeric material that may be represented by a hyperelastic material model, and that ranges in stiffness from a soft silicon to a hard rubber, that representation is provided merely in the interests of conceptual clarity. In various implementations, material 250 may be a hyperelastic material or a viscoelastic material as those terms are known in the art.

Referring first to uniaxial testing apparatus 240a, uniaxial testing apparatus 240a is configured to stretch material 250 in a single direction, e.g., in the “x” direction. As shown in FIG. 2, uniaxial testing apparatus 240a includes “x” direction stationary load cell 244x to which a first end of material 250 is attached, and carriage 246x moveable in the “x” direction in response to actuator 248x. A second end of material 250, opposite the first end, is attached to stationary load cell 224x attached to moveable carriage 246x, such that movement of carriage 246x away from load cell 244x in the “x” direction causes material 250 to be stretched in the “x” direction only. Moreover, attachment of material 250 to “x” direction stationary load cell 244x establishes boundary conditions 252x during the physical test performed using uniaxial testing apparatus 240a. In implementations in which uniaxial testing apparatus 240a is used to perform a physical test on material 250, boundary conditions 252x may be utilized as disclosed herein to improve the simulation accuracy of material 250 when determining its one or more material characteristics 158.

Analogously, biaxial testing apparatus 240b is configured to stretch material 250 in perpendicular directions, e.g., in the “x” direction and in the orthogonal “y” direction. As further shown in FIG. 2, biaxial testing apparatus 240b includes “x” direction stationary load cell 244x to which a first end of material 250 is attached, and carriage 246x moveable in the “x” direction in response to actuator 248x. A second end of material 250, opposite the first end, is attached to stationary load cell 224x attached to moveable carriage 246x, such that movement of carriage 246x away from load cell 244x in the “x” direction causes material 250 to be stretched in the “x” direction. Moreover, attachment of material 250 to stationary load cell 244x establishes “x” direction boundary conditions 252x during the physical test performed using biaxial testing apparatus 240b.

In addition, and as also shown in FIG. 2, biaxial testing apparatus 240b includes “y” direction stationary load cell 244y to which a third end of material 250 perpendicular to the first and second ends is attached, and carriage 246y moveable in the “y” direction in response to actuator 248y. A fourth end of material 250 opposite the third end attached to stationary load cell 224y is attached to moveable carriage 246y, such that movement of carriage 246y away from load cell 244y in the “y” direction causes material 250 to be stretched in the “y” direction. Moreover, attachment of material 250 to stationary load cell 244y establishes “y” direction boundary conditions 252y during the physical test performed using biaxial testing apparatus 240b. In implementations in which biaxial testing apparatus 240b is used to perform a physical test on material 250, boundary conditions 252x and boundary conditions 252y may be utilized as disclosed herein to improve the simulation accuracy of material 250 when determining its one or more material characteristics 158.

It is noted that in conventional analytical model fitting, only the mid-part of the test specimen is considered. This mid-part is uniformly stretched in one direction for a uniaxial test, and in two directions for the biaxial test. In all other directions, the stress is zero. However, according to present novel and inventive solution, the boundary conditions are modeled in simulation, and the simulated test specimen undergoes non-uniform stretching. Because the effects at the boundaries are taken into account in the present approach, we can perform less mechanical testing while increasing the accuracy of the estimated model parameters.

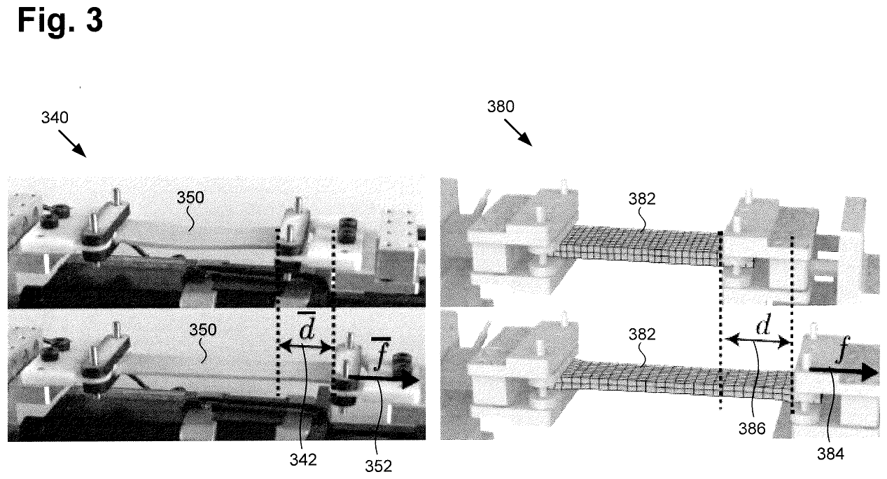

FIG. 3 shows a diagram of a physical test performed on material 350 using uniaxial testing apparatus 340 and corresponding simulation 380 of the physical test using parameterized model 382 of material 350, according to one implementation. Also shown in FIG. 3 are physical testing force f̅ 352, resulting displacement d̅ 342 (hereinafter also “result 342” or “obtained result 342”), simulated force f 384, and simulated displacement d 386 (hereinafter also “simulated result 386”).

Uniaxial testing apparatus 340 corresponds in general to uniaxial testing apparatus 240a, in FIG. 2, as well as to material testing apparatus 140 in FIGS. 1A and 1B. Consequently, testing apparatus 140/240a may share any of the characteristics attributed to uniaxial testing apparatus 340 by the present disclosure, and vice versa. In addition, material 350 and obtained result 342 correspond respectively in general to material 250, in FIG. 2, and obtained result 142, in FIG. 1. That is to say, material 250 and obtained result 142 may share any of the characteristics attributed to respective material 350 and obtained result 342 by the present disclosure, and vice versa.

By way of overview of the material simulation solution disclosed by the present application, and referring to the exemplary physical testing and corresponding simulation depicted in FIGS. 2 and 3, testing apparatus 140/240a/240b/340 is configured to pull on material 250/350 in one or two directions. The displacement d̅ 342 at each moving end of material 250/350 is recorded, as well as the force f̅ 352 in the direction or directions causing each displacement.

Representing material 250/350 with a non-analytical parameterized model, such as a finite element discretization, for example, the hyperelastic material parameters that minimize differences between simulated and measured displacements d 386 and d̅ 342 are sought by minimizing objectives of the form

$$\frac{1}{2} {( d - \overline{d} )}^{2}$$

for every moving end, and force-displacement material.

To improve robustness to noise, the forces f 384 applied in simulation 380 are treated as parameters, and the displacement objectives and force objectives of the form

$$\frac{1}{2} {( f - \overline{f} )}^{2}$$

weighted by w_{f} are jointly optimized.

Summing up displacement and force objectives for every moving interface k, and every material sample i, the parameters p that minimize the following characterization objective are sought:

$${g}_{char} = {\sum }_{k , i} \frac{1}{2} {( {d}_{k} ( p , {f}_{k}^{i} ) - {\overline{d}}_{k}^{i} )}^{2} + {w}_{f} {\sum }_{k , i} \frac{1}{2} {( {f}_{t}^{i} - {\overline{f}}_{k}^{i} )}^{2} . \qquad ( Equation 1 )$$

To minimize this objective, we express standard finite element degrees of freedom that are rigidly moving with the load cells and carriages shown in FIG. 2 with displacements d along global coordinate axes, e.g., an “x” axis and perhaps an orthogonal “y” axis. We then solve the equilibrium constrained problem:

$${min}_{p , {f}_{k}^{i}} {g}_{c h a r} ( p , {f}_{k}^{i} )$$

$$subject to : {f}_{i n t} ( p ) = {f}_{e x t} ( {f}_{k}^{i} ) , ∀ k , i$$

$${p}_{l o} \leq p \leq {p}_{up}$$

where we ask external forces fₑₓₜ to be in balance with the internal response fᵢₙₜ of the sample of material 250/350. In order to keep material parameters within physically feasible ranges, they are bound from above and below where necessary. It is noted that this formulation enables the combined characterization from different tests (e.g., from uniaxial and biaxial test results), assigning test samples of material 250/350 having different dimensions the same material parameters p.

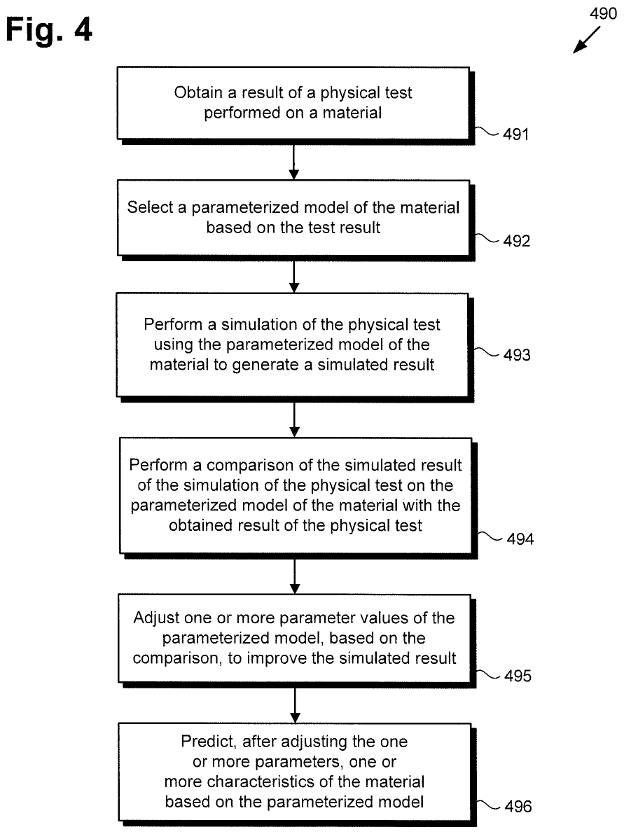

The functionality of systems 100 and 130 including differentiable material simulation software code 110 will be further described by reference to FIG. 4 in combination with FIGS. 1, 2, and 3. FIG. 4 shows flowchart 490 presenting an exemplary method for use by a system, such as systems 100 and 130, in FIGS. 1A and 1B, for simulating material characteristics, according to one implementation. With respect to the method outlined in FIG. 4, it is noted that certain details and features have been left out of flowchart 490 in order not to obscure the discussion of the inventive features in the present application.

Referring to FIG. 4 in combination with FIGS. 1, 2, and 3, flowchart 490 begins with obtaining result 142/342 of a physical test performed on material 250/350 (action 491). Action 491 may be performed in one of at least two ways by differentiable material simulation software code 110, executed by hardware processor 104 or 134.

In some implementations, testing apparatus 140/240a/240b/340 may operate independently of system 100 or user system 130, in which use cases obtaining result 142/342 of the physical test performed on material 250/350 may correspond to simply receiving result 142/342 from testing apparatus 140/240a/240b/340. However, in other implementations, as noted above, testing apparatus 140/240a/240b/340 may be a component of system 100, or may be controlled by user system 130. In those implementations, obtaining result 142/342 in action 491 may include executing differentiable material simulation software code 110 to control testing apparatus 140/240a/240b/340 to perform the physical test on material 250/350.

As described above by reference to FIGS. 2 and 3, the physical test performed on material 250/350 corresponding to a hyperelastic material model may include pulling on and stretching material 250/350. Such stretching may be performed unilaterally, as shown and described by reference to FIGS. 2 and 3, or bilaterally as shown and described by reference to FIG. 2.

Flowchart 490 continues with selecting parameterized model 382 of material 250/350 based on obtained result 142/342 (action 492). The selection of parameterized model 382 of material 250/350 based on obtained result 142/342 may be performed by differentiable material simulation software code 110, executed by hardware processor 104 or 134. In some implementations, parameterized model 382 may be an existing model usable as is, while in other implementations parameterized model 382 may be an existing model that is customized for material 250/350. In yet other implementations, parameterized model 382 may be developed specifically for material 250/350.

Parameterized model 382 of material 250/350 may include a differentiable mathematical representation of material 250/350, such as a differentiable finite element representation of material 250/350. In the interests of conceptual clarity, the discussion below first describes how to compute analytical gradients of a single sample of material 250/350 tested on uniaxial test apparatus 140/240a/340, and then provides a roadmap for making a finite element representation differentiable.

Referring to FIG. 3, for a single displacement-force sample (d̅, f̅) we may distinguish between the finite element degrees of freedom that describe the deformed configuration x within material 250/350, and the displacement d of bonded degrees of freedom that move along a coordinate axis. Here, x is a vector whose size equals three times the number of nodes that do not lie on an interface that moves.

To disclose numerical optimization of the characterization problem expressed as Equation 1 above, it is sufficient to study the single sample case. For the use case in which a single sample of material 250/350 undergoes a physical test, as shown in FIG. 3, we seek optimal parameters p and an external force f that is close to the measured force f̅, and that explain the measured displacement d̅ with a simulated displacement d as follows:

$${g}_{char} ( y , z ( y ) ) = \frac{1}{2} {( d ( y ) - \overline{d} )}^{2} + {w}_{f} \frac{1}{2} {( f - \overline{f} )}^{2} . \qquad ( Equation 2 )$$

In this simplified form of the objective expressed by Equation 1, we collect the unknown optimization variables in a vector y=(p, f), and the elastic response of the model in a vector z=(x, d) as this aids in keeping the notation concise.

For numerical optimization, an analytical gradient is required. Due to the implicit dependence of the elastic response on the unknowns, the gradient is the total derivative:

d_{y}g_{char}=∂_{y}g_{char}+∂_{z}g_{char}d_{y}z. (Equation 3)

Most entries of the two partial derivatives, ∂_{y}g_{char}=(0^{T}, f−f̅) and ∂_{z}g_{char}=(0^{T}, d−d̅), are zero because the objective does not directly depend on the parameters p or the deformed degrees of freedom x (it is noted that a numerator-layout may be utilized in which gradients are row vectors). To compute the derivative d_{y}z of the elastic response of material 250/350, we can make use of the equilibrium constraint:

f(y,z(y))−fᵢₙₜ(p,z(y))−(0^{T},f)=0^{T} (Equation 4)

that balances the nonlinear internal forces with the applied force. Because an elastic response that fulfills this constraint for sets of parameters and forces can be found in a neighborhood of a given y, the constraint can be considered constant, and its derivative to be zero:

d_{y}f=∂_{y}f+∂_{z}fd_{y}z=0^{T}. (Equation 5)

Flowchart 490 continues with performing a simulation of the physical test performed on material 250/350 by testing apparatus 140/240a/240b/340, using parameterized model 382 of material 250/350 to generate simulated result 386 (action 493), and performing a comparison of simulated result 386 with obtained result 142/342 (action 494). Flowchart 490 further continues with adjusting parameter values of parameterized model 382, based on the comparison performed in action 494, to improve simulated result 386 (action 495), followed by predicting one or more characteristics 158 of material 250/350 based on the adjusted model parameters (action 496). For example, where the material characteristic being modeled is the elastic response of a material, action 495 results in a parameterized model and corresponding material parameters that make it possible to predict the elastic response of the material in simulation, at any point in time. Actions 493, 494, 495, and 496 may be performed by differentiable material simulation software code 110, executed by hardware processor 104 or 134.

The application of the implicit function theorem discussed above by reference to action 492 provides a recipe to compute analytical gradients: Whenever the set of unknowns y is updated, a simulation is performed to find the equilibrium z(y) for which the internal and external forces are in balance. That is to say simulated result 386 is compared to obtained result 142/342 under a constraint that ensures that applied forces are in equilibrium with the elastic response of material 250/350 used as the test sample. The derivative of the elastic response can then be computed by solving the system of equations d_{y}z=−(∂_{z}f)⁻¹∂_{y}f, and Equation 3 above can be evaluated. For the multi-interface, multi-sample case, the simulations may be performed for every sample i of material 250/350, taking into account all forces k that act concurrently.

Because internal forces do not directly depend on f, the partial derivative ∂_{y}f of the equilibrium constraint can be computed by forming the derivative ∂_{z}fᵢₙₜ, and subtracting the constant matrix with a 1 in the last row and column. The partial derivative ∂_{z}f is the non-constant tangent stiffness or stiffness matrix ∂_{z}fᵢₙₜ, which can be computed from the standard matrix by applying the chain rule.

This formulation can be used to fit common hyperelastic material models to acquired displacement-force curves. While the technique is applicable to any model for which a strain energy density Ψ exists, in the interests of conceptual clarity, the present approach is described by reference to three representative hyperelastic materials that are commonly used for elastomer simulation, and are available in commercial packages: the Neo-Hookean model, a generalized Mooney-Rivlin model, and the 3^{rd}-order Yeoh model.

Conditioned on having a simulator that enforces incompressibility with constraints, the present method could be used to fit both compressible and incompressible models. However, while elastomers are commonly considered incompressible or nearly incompressible, finite element implementations often assume a compressible model because constraint-based approaches tend to increase the time and implementational complexity, or can cause locking, as known in the art. Consequently, the present approach utilizes a compressible model to increase computational efficiency and to reduce cost.

For compressible models, it is important to fit parameters that do not lead to simulation instabilities. To ensure stability, material 250/350 may be parameterized using the consistency with linear elasticity, setting the Poisson's ratio ν to a value that is sufficiently far from 0.5. The remaining parameters may then be fitted.

Volume preservation terms that depend on the determinant of the deformation gradient, J=detF, may be exponentiated with an even number to get rid of the sign. Hence, it is important to keep corresponding parameters from taking on negative values. Negative values for parameters that weigh terms that depend on the first or second invariants, I₁ or I₂, can undesirably lead to negative energies in moderately deformed material 250/350 of poor quality, or highly-stretched material 250/350 of high quality. Because negative energies are non-physical, it may be advantageous or desirable to bound these parameters from below, to keep them non-negative.

To demonstrate the present method, the following compressible versions of the Neo-Hookean model are used:

$${Ψ}_{N H} = \frac{μ}{2} ( {I}_{1} - 3 - 2 ln J ) + \frac{λ}{2} {( ln J )}^{2} ,$$

as well as a generalized Mooney-Rivlin model:

Ψ_{MR}=C₁₀(Ī₁−3)+C₀₁(Ī₂−3)+C₁₁(Ī₁−3)(Ī₂−2)+D₁(J−1)²,

and the 3^{rd}-order Yeoh model:

Ψ_{Y}=C₁₀(Ī₁−3)+C₂₀(Ī₁−3)²+C₃₀(Ī₁−3)³+D₁(J−1)²+D₂(J−1)⁴+D₃(J−1)⁶.

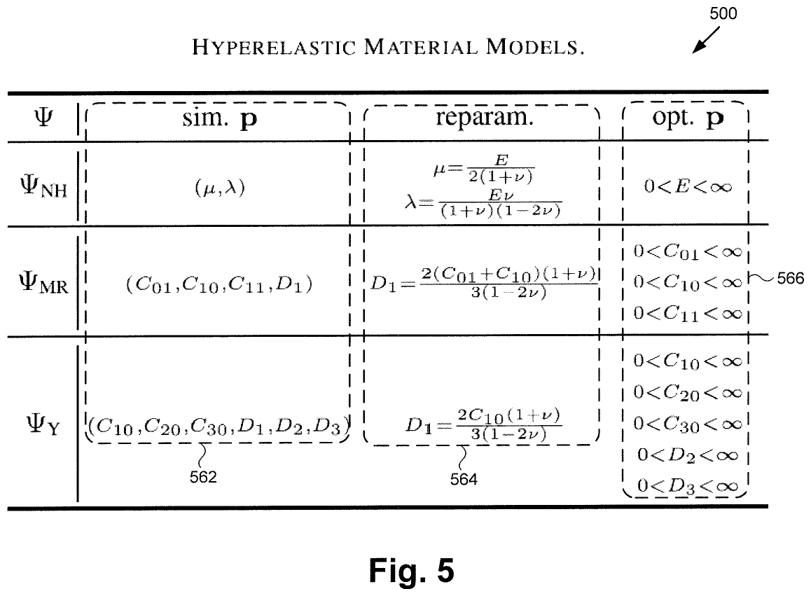

Referring to FIG. 5, Table 500 in that figure summarizes the reparameterizations 564 of their simulation parameters 562, and the corresponding optimization parameters 566 with their bounds. If Poisson's ratio is included in optimizations, it is bound from above and below: 0<ν<0.5−ε for ε>0.

To be compatible with a standard finite element representation, the coupling of a subset of degrees of freedom to rigidly moving parts and the differentiation of internal forces with respect to parameters requires further discussion. While the characterization described above is independent of the element type and its order, it may be advantageous or desirable to represent material 250/350 being tested as being composed of equally-sized hexahedral elements. The reason for this is two-fold: (1) numerical integration using standard Gauss quadrature is more accurate for hexahedral than for tetrahedral elements, and (2) there is no distortion in the mapping from real to natural coordinates for cubical elements. Consequently, by using cubical and equally-sized hexahedral elements, the resolution dependence and order dependence of fitted parameters can be studied, thereby advantageously avoiding any bias due to elements of different shape and size.

To run coupled simulations, evaluations of the internal forces fᵢₙₜ, and the tangent stiffness ∂_{z}fᵢₙₜ are necessary. To evaluate the undeformed or deformed configuration at the neutral coordinates ξ∈ [symbol] ³ within an element, the standard Lagrange shape functions Nᵢ(ξ) corresponding to nodes i of the element are relied upon. For example, for the undeformed configuration, we interpolate the undeformed nodes Xᵢ∈ [symbol] ³ as:

X(ξ)=Σᵢ₌₁ⁿXᵢNᵢ(ξ). (Equation 6)

To measure strains within an n-node element, the deformation gradient is defined as the product of the Jacobian of the interpolated deformed nodes xᵢ, and the inverse of the Jacobian X_{ξ} of the undeformed configuration:

F(ξ)=(Σᵢ₌₁ⁿxᵢ∂_{ξ}Nᵢ(ξ))X_{ξ}⁻¹(ξ) (Equation 7)

where the partial derivatives ∂_{ξ} of the shape functions are, in general, not constant.

Applying external forces or prescribing displacements, energy is stored within the discretized solid model of material 250/350. To determine this internal energy, the strain energy density Ψ of the hyperelastic material is integrated over the volume ε of the isoparametric element, taking the change of variables from real to natural coordinates into account:

Eᵢₙₜ(x̅,p)=Σₑ∫_{ε}Ψ(F(x̅,ξ),p)det X_{ξ}(ξ)dξ. (Equation 8)

As indicated, the internal energy depends on the deformed nodes of the discretized mesh model, collected in a vector x̅ having a size set to three times the number of nodes, as well as the material parameters p whose number varies across material models.

In order to evaluate the energy, the integral may be approximated over ε with an m-point Gauss quadrature:

Σⱼ₌₁^{m}wⱼΨ(F(x̅,ξⱼ),p)det X_{ξ}(ξⱼ). (Equation 9)

where wⱼ is the weight that corresponds to point ξⱼ. Softer elastomers such as soft silicones tend to sag significantly under gravity, especially in the low-strain range. As a result, depending on material 250/350, it may be important to account for the work done by gravity. To this end, the dot product can be integrated between the gravitational vector g and the interpolated displacement u(ξ)=Σᵢ₌₁ⁿ(xᵢ−Xᵢ)Nᵢ(ξ) over the volume enclosed by the solid:

E_{grav}(x̅)=Σₑ∫_{ε}ρg^{T}u(ξ)det X_{ξ}(ξ)dξ, (Equation 10)

approximating the integral with the same quadrature scheme.

Another source of external energy is work done by nodal forces fᵢ∈ [symbol] ³:

Eₑₓₜ(x̅)=Eᵢfᵢ^{T}(xᵢ−Xᵢ). (Equation 11)

To compute the deformed configuration, the total potential energy:

E(x̅)=Eᵢₙₜ(x̅,p)−E_{grav}(x̅)−Eₑₓₜ(x̅) (Equation 12)

is minimized to first-order optimality, ∂ₓE=0, using a standard Newton.

As discussed above, in an energy-based formulation, the internal energy Eᵢₙₜ(x̅, p) integrates the potential energy stored in all deformed elements. This energy depends on the nodal degrees of standard elements x̅, and the hyperelastic material parameters. To compute equilibria, the first and second derivative of this energy can be used, namely the internal forces fᵢₙₜ=∂_{x̅}Eᵢₙₜ and the tangent stiffness matrix ∂_{x̅}fᵢₙₜ.

To couple deformed nodes x on the bonding interface to the constrained displacement d along a coordinate axis, the standard degrees of freedom can be assumed to be split into noninterface and interface nodes, x̅=(x, x). The mapping x̅(z)=(|x, X+Id) can then be defined, where the displacement d is added to the rest configuration X of the interface nodes, with I set to an identity matrix of appropriate size. The derivative of this mapping, ∂_{z}x̅, is the constant block diagonal matrix, diag(I, 1), with identity of size of x, and a column vector 1 with entries set to 1.

This mapping enables the evaluation of internal forces and the tangent stiffness matrix of the coupled problem with standard quantities:

fᵢₙₜ=∂_{x̅}Eᵢₙₜ∂_{z}x̅, and (Equation 13A)

∂_{z}fᵢₙₜ=(∂_{z}x̅)^{T}∂_{x̅x̅}Eᵢₙₜ∂_{z}x̅. (Equation 13B)

With the coupling described above, we can correctly predict the non-uniform response of material 250/350 that integrates to the force value f.

To compute the derivative ∂ₚfᵢₙₜ, symbolic differentiation can be used to evaluate the per-element Jacobians of the internal energy Eᵢₙₜ with respect to incident nodes, and material parameters. Similarly to the assembly of the tangent stiffness matrix, we assemble elemental contributions to the Jacobian ∂_{px̅}Eᵢₙₜ, then apply the chain rule ∂ₚfᵢₙₜ=∂_{px̅}Eᵢₙₜ∂_{z}x̅.

In some implementations, the present method may conclude with action 496, described above. However, and although not shown by FIG. 4, in other implementations the method outlined by flowchart 490 may further include manufacturing object 170 based on one or more characteristics 158 of material 250/350 predicted in action 496. That is to say, in some implementations, computing platform 102 or user system 130 may be configured to utilize or otherwise control manufacturing system 160 to manufacture object 170 based on one or more characteristics 158.

Object 170 manufactured based on one or more characteristics 158 of material 250/350 may take a variety of forms. For example, in one use case, object 170 may be an artificial skin for use in medicine, such as to promote healing in burn victims or victims of other traumatic injury. In other implementations, object 170 may be a surface covering or skin for use in manufacture of a robot or other type of machine. In those latter implementations, one or more internal components of the robot or other type of machine may also be manufactured or selected based on one or more characteristics 158.

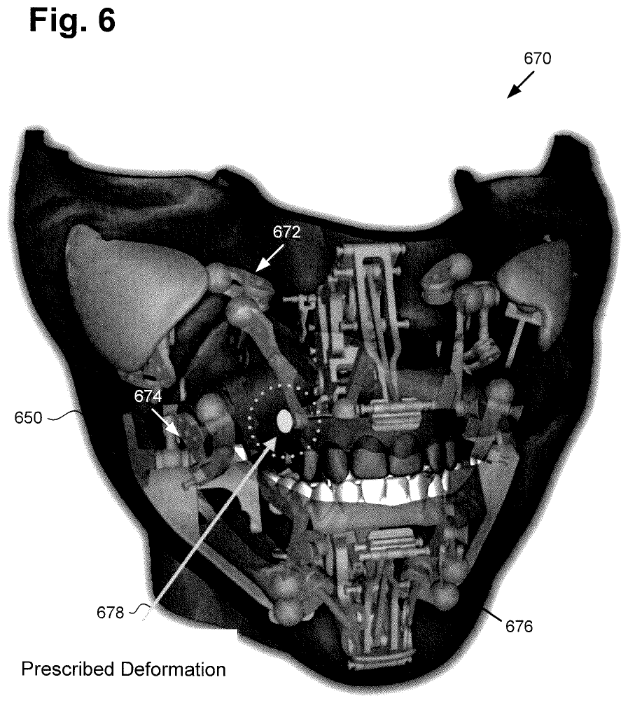

For example, referring, to FIG. 6, FIG. 6 shows a cutaway view of object 670 in the form of a head portion of a robot manufactured based on material characteristics 158 simulated by the system 100 or user system 130 according to the methods disclosed in the present application, according to one implementation. As shown in FIG. 6, object 670 includes material 650 used as a skin for object 670, as well as internal components of object 670, such as motors 672, 674, and 676 configured to render facial expressions through deformation of the skin surface provided by material 650.

Object 670 corresponds in general to object 170, in FIGS. 1A and 1B, while material 650 corresponds in general to material 250/350 in FIGS. 2 and 3. Consequently, object 170 and material 250/350 may share any of the characteristics attributed to object 670 and material 650 by the present disclosure, and vice versa.

As indicated in FIG. 6, in order for the expressions rendered through deformation of the skin surface provided by material 250/350/650 to have verisimilitude, the deformations of the skin surface provided by material 650 should conform to predetermined prescribed deformations represented by prescribed deformation 678. That is to say, because the simulation representation disclosed by the present application predicts the behavior of artificial skin under applied loads more accurately than conventional analytical representations, we see better correspondence between simulated results, and the physical skin under the same actuation. However, because deformation of the skin surface provided by material 250/350/650 depends on the one or more characteristics 158 of material 250/350/450, the accurate prediction of one or more characteristics 158 advantageously enables hardware costs savings for manufacture of robot object 170/670. That is to say, the size or sizes of one or more of motors 672, 674, and 676 included in object 170/670 may be substantially minimized based on the one or more characteristics 158 of material 250/350/650 predicted in action 496.

In some implementations, it may advantageous or desirable to render one or more characteristics 158 of material 250/350/650 on display 108 of material simulation system 100 for review by a system administrator, or to render one or more characteristics 158 on display 138 for review by user 131. In those implementations, hardware processor 104 or hardware processor 134 may execute differentiable material simulation software code 110 to render one or more characteristics 158 of material 250/350/650 on respective display 108 or display 138.

However, it is noted that, in some implementations, hardware processor 104 or 134 may execute differentiable material simulation software code 110 to perform actions 491, 492, 493, 494, 495, and 496 (hereinafter “actions 491-496”), as well as subsequent action 497 in an automated process. It is further noted that, as used in the present application, the term “automated” refers to systems and processes that do not require the participation of a human user, such as a human designer or engineer. Although, as noted above, in some implementations, a human designer or engineer, such as user 131, may review the performance of the automated systems and automated methods described herein, that human involvement is optional. Thus, in some implementations, the methods described in the present application may be performed under the control of hardware processing components of the disclosed systems.

Thus, the present application discloses systems and methods for simulating material characteristics that improve on the state of the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory;
a software code stored in the system memory;
the hardware processor being configured to execute the software code to:
obtain a result of a physical test performed on a material;
select a parameterized model of the material based on the obtained result;
perform a simulation of the physical test using the parameterized model of the material to generate a simulated result;
perform a comparison of the simulated result of the simulation of the physical test on the parameterized model of the material with the obtained result of the physical test on the material;
adjust at least one parameter value of the parameterized model, based on the comparison, to improve the simulated result; and
predict, after adjusting the at least one parameter value, at least one characteristic of the material based on the parameterized model of the material.

2. The system of claim 1, wherein the material is a hyperelastic material or a viscoelastic material.

3. The system of claim 1, wherein the parameterized model of the material comprises a differentiable mathematical representation of the material.

4. The system of claim 1, wherein the parameterized model of the material comprises a finite element representation of the material.

5. The system of claim 1, wherein the system further comprises a testing apparatus communicatively coupled to the computing platform, and wherein the hardware processor is configured to further execute the software code to control the testing apparatus to perform the physical test on the material.

6. The system of claim 1, wherein the system is further configured to manufacture an object based on the at least one predicted characteristic.

7. The system of claim 6, wherein the object is a robot, and wherein the material provides a skin for the robot.

8. The system of claim 6, wherein an increased prediction accuracy enabled by the software code results in reduced hardware costs for manufacture of the object.

9. A method for use by a system including a computing platform having a hardware processor and a system memory storing a software code, the method comprising:
obtaining, by the software code executed by the hardware processor, a result of a physical test performed on a material;
selecting, by the software code executed by the hardware processor, a parameterized model of the material based on the obtained result;
performing, by the software code executed by the hardware processor, a simulation of the physical test using the parameterized model of the material to generate a simulated result;
performing, by the software code executed by the hardware processor, a comparison of the simulated result of the simulation of the physical test on the parameterized model of the material with the obtained result of the physical test on the material;
adjusting at least one parameter value of the parameterized model, by the software code executed by the hardware processor, based on the comparison, to improve the simulated result; and
predicting, by the software code executed by the hardware processor after adjusting the at least on parameter value, at least one characteristic of the material based on the parameterized model of the material.

10. The method of claim 9, wherein the parameterized model of the material comprises a differentiable mathematical representation of the material.

11. The method of claim 9, wherein the parameterized model of the material comprises a finite element representation of the material.

12. The method of claim 9, wherein the system further comprises a testing apparatus communicatively coupled to the computing platform, and wherein the method further comprises:
controlling, by the software code executed by the hardware processor, the testing apparatus to perform the physical test on the material.

13. The method of claim 9 further comprising manufacturing an object based on the at least one predicted characteristic.

14. The method of claim 13, wherein the object is a robot, and wherein the material provides a skin for the robot.

15. The method of claim 13, wherein an increased prediction accuracy enabled by the software code results in reduced hardware costs for manufacture of the object.

16. An object produced according to a method comprising:
obtaining a result of a physical test performed on a material;
selecting a parameterized model of the material based on the obtained result;
performing a simulation of the physical test using the parameterized model of the material to generate a simulated result;
performing a comparison of the simulated result of the simulation of the physical test on the parameterized model of the material with the obtained result of the physical test on the material;
adjusting at least one parameter value of the parameterized model, based on the comparison, to improve the simulated result;
predicting, after adjusting the at least one parameter value, at least one characteristic of the material based on the parameterized model of the material; and
manufacturing the object based on the at least one predicted characteristic.

17. The object of claim 16, wherein the parameterized model of the material comprises a differentiable mathematical representation of the material.

18. The object of claim 16, wherein the parameterized model of the material comprises a finite element representation of the material.

19. The object of claim 16, wherein the object is a robot, and wherein the material provides a skin for the robot.

20. The object of claim 16, wherein an increased prediction accuracy enabled by the parameterized model of the material results in reduced hardware costs for manufacture of the object.
